(19) United States
(12) Patent Application Publication
(10) Pub. No.: US 2019/0026647 A1
(43) Pub. Date: Jan. 24, 2019

(54) Authoring System for Subject Matter Experts (SMEs) to Develop a Computer-Based Question and Answer (QA) system for their Instructional Materials

(71) Applicant: Mark Wayne Salisbury, Fridley, MN (US)

(72) Inventor: Mark Wayne Salisbury, Fridley, MN (US)

(21) Appl. No.: 15/655,820

(22) Filed: Jul. 20, 2017

(51) Int. Cl. G06N 99/00; G06F 17/30

(52) U.S. Cl. CPC G06N 99/005; G06F 17/3043

(57) ABSTRACT

The present invention is a system and method for subject matter experts (SME) to develop a computer-based Question and Answer (QA) system for their own instructional materials. The authoring system is made up of third party components that have been augmented with templates comprising content, component connections, and computer logic needed to develop a computer-based QA system for instructional materials. The invention employs a method to guide SMEs in using the authoring system to create a computer-based QA system. The resulting QA system uses learning resources to answer learner questions posed in natural language that relate to the learning objectives of the instructional materials, the type of knowledge the learner is seeking, and the type of learner to identify the intent behind learner questions. The authoring system and method greatly reduces the work of developing a computer-based QA system and improves its accuracy in answering questions about instructional materials.

### FIELD OF THE INVENTION

This invention relates to the development of computer-based Question and Answer (QA) systems, and, more particularly, it's an authoring system and a method for Subject Matter Experts (SMEs) to develop a QA system for their instructional materials.

### DESCRIPTION OF THE BACKGROUND

When instructional materials are made available to learners, they frequently have questions for the person that created the materials. This is true for informal help pages and it's also true for more formal educational experiences such as an online college course. A problem arises when learners desire to be able to ask questions in natural human language and get an answer quickly. Given the advances in computer technology, the obvious answer to this problem is to provide a computer-based Question and Answer (QA) system to process learner questions and generate answers to their questions in natural language that has links to other media resources like a good instructor would do in an email response.

However, natural language understanding has, and continues to be, a difficult task for computers. US Patent Application, US 2003/0144831, “Natural language processor,” filed on Jul. 31, 2003, summed up the difficulties well:

“Working in the favor of one attempting to create a natural language processor, however, are a few facts. It has been said that the average person, while knowing tens of thousands of words and their meanings, uses fewer than two thousand unique words in the course of a day. Also, from studies of voice communication it is known that the average verbal message is between seven or eight words.

These facts can give us some idea of the size of the challenge that one faces in creating a natural language processor that can understand a person having a typical vocabulary and speaking in an average manner. Even assuming that we know which two thousand words an individual is going to use in a given day, such an individual could conceivably utter approximately 4.1×1020 distinct, nine word communications, assuming no repetition of words in these communications, (i.e., 2000×1999× . . . ×1992 communications). Thus, the task of recognizing all the possible concepts contained within such an exceedingly large number of distinct communications seems initially to be quite unmanageable.” (Table 1, below lists this and the other Prior Art references.)

Adding to the complexity of developing a natural language processing unit, it was not feasible for a subject matter expert (SME) to develop a computer-based QA system for his or her instructional materials before this invention. SMEs needed instructional design knowledge to create effective answers that could be delivered in response to learner questions. SMEs have addressed this issue in the past by consulting instructional designers. However, adding this expertise, increases the time and resources (i.e., costs) for developing the instructional materials.

Instructional designers know how to design effective instructional materials through the use of learning objectives (Bloom, 1956; Anderson, et al., 1998). In the book, iLearning: How to Create an Innovative Learning Organization (Salisbury, 2009a), it shows how to use learning objectives to create instructional materials that can be used for informal help pages and more formal educational experiences such as online college courses. The book also shows how learning scientists have extended the use of learning objectives to include addressing four different types of knowledge that learners may want to access given their level of expertise (Anderson, 1998). The difference types of knowledge described are factual, conceptual, procedural, and metacognitive knowledge. More sophisticated designs of instructional materials now include addressing learning objectives within the context of these different types of knowledge. For more descriptions of using different types of knowledge to address learning objectives, see (Salisbury, 2014; 2009b; Salisbury, 2008a; Salisbury, 2008b).

The invention described here takes a different approach to human learning than many of those in the area of “learning management systems.” Historically, the approach used with many learning management systems is one of using a strategy to guide students through a maze of nodes modelled from the content of a course. Students are directed to the next logical node when they have completed the content in the previous node. The navigation path is used to suggest content from the course for presentation to learners as they proceed through the course. It applies the notion of “mastery learning” where students are directed by the system through the content as they master it. A contemporary example of this approach is found described in U.S. Pat. No. 6,827,578, entitled, “Navigating e-learning course materials,” filed in Dec. 7, 2004.

The invention described here takes a different approach from many learning management systems in that it is based on the assumption that learners know what knowledge they are seeking. They desire to ask questions of a QA system much like they would ask the SME who developed the instructional materials.

This invention also takes a different approach than those taken in the area of ‘intelligent tutors.” Historically, intelligent tutors have compared a model of the problem-solving knowledge of an expert with a model of the learner's problem-solving knowledge. Based on the differences between the two models, instructional materials are presented to the learner. This goes back to the development of BUGGY (Burton, 1982). Many newer designs of intelligent tutors still follow this approach. One example is U.S. Pat. No. 8,750,782, entitled, “Building and delivering highly adaptive and configurable tutoring systems,” filed on Jun. 10, 2014. It follows this approach and compares a problem-solving model it creates for the learner with the problem-solving model it has for an expert. It “tutors” the learner in areas where the learner's model is deficient to the expert model. Again, the invention described here, works on the assumption that learners know what knowledge they are seeking and they desire to ask questions of a QA system much like they would ask a SME in the content area.

Additionally, before this invention, SMEs would need programming knowledge to develop or configure a natural language processing (NLP) unit. Similarly, SMEs have addressed this issue in the past by consulting programming staff. Programmers would help with developing programming code and computer logic (i.e., the rules for human/computer interaction) for determining the intent behind learner questions and generating a response to the questions. And, of course, this increases the time and resources (i.e., costs) for developing instructional materials that have a QA system.

This is the case for U.S. Pat. No. 5,920,838, entitled “Reading and pronunciation tutor,” filed on Jul. 6, 1999. It described a computer implemented tutor that processed input and generated responses. While it had its own unique and effective approach to processing input and generating responses, it still was not an apparatus that SMEs could use to develop a QA system for their own instructional materials. A lot of programming skills are needed to create a new system for a new content area.

Related to programming skills, is the experience needed with NLP units to build the complex logic required to process and respond to a wide variety of questions. This expertise is linguistic in nature and expensive to procure.

The need for instructional design, programming, and natural language linguistic skills to develop QA systems have made it prohibitively difficult and expensive for SMEs to develop their own QA systems for their instructional materials. As a result, these complicated and expensive QA systems have only been developed for high profile or highly used instructional applications. What is needed is a means for SMEs to easily and quickly develop a computer-based QA system for their instructional materials without help from instructional designers, programmers, or natural language linguistic specialists.

There is a long history in attempting to provide the systems and methods for SMEs to easily and quickly develop a computer-based QA system. The software tool, PARGEN (Salisbury, 1988), is an early example of these attempts. PARGEN lowered the threshold of programming skills needed to develop a computer-based QA system. Since it was based on semantics instead of syntax, it also lowered the natural language linguistic complexity needed to develop a NLP unit. However, like so many similar efforts, PARGEN did not decrease the time and resources (i.e., costs) enough to make it feasible for SMEs to develop a QA system for their own instructional materials.

Other earlier efforts took a different approach to lowering the natural language linguistic complexity needed to develop a NLP unit. One of these was the GERBAL system, (Salisbury, et al., 1990a, 1990b), which used graphical input to reduce the possible user intentions that would have to be considered by a speech recognizer. Like people, GERBAL used graphical input to disambiguate verbal input to determine the intent behind the input. GERBAL was an early example of how additional information, in this case, graphical information, could possibly decrease the time and resources (i.e., costs) enough to make it feasible for SMEs to develop a QA system for their own instructional materials.

More sophisticated methods to gain information to disambiguate verbal input have been developed since GERBAL was built. One example is U.S. Pat. No. 7,519,529, entitled “System and methods for inferring informational goals and preferred level of detail of results in response to questions posed to an automated information-retrieval or question-answering service,” filed on Apr. 14, 2009. This patent describes a system and methods that employ supervised learning and statistical analysis on a set of queries suitable to be presented to a QA system. While sophisticated techniques are employed to gather user information to disambiguate verbal input to determine the intent behind the input, the resulting system and methods still require considerable programming and linguistics expertise to be utilized for a new and specific NLP application. Thus, these techniques cannot be used by SMEs to develop a QA system for their own instructional materials.

Recent efforts to build on the work of IBM's Watson have also produced more sophisticated methods that focus on the answering function of QA systems. One example is US Patent Application, US 2013/0007055 A1, “Providing Answers to Questions Using Multiple Models to Score Candidate Answers,” filed on Jan. 3, 2013. It employs multiple methods to try to understand a wide variety of possible user questions. In the process, it identifies candidate answers to the input query and produces scores for each of the candidate answers, and ultimately makes one or more selections for an answer.

A second example of more recent work on QA systems is US Patent Application, US 2016/0132590 A1, “Answering Questions Via a Persona-Based Natural Language Processing (NLP) System,” filed on May 12, 2016. A mechanism is described where the answer to the input question is output in a form representative of a requested persona. Say, for example, a user wanted to ask questions about the American Civil War and selected Abraham Lincoln as their persona. They could then ask the system the question “What caused the American Civil War?” and it would answer from the perspective of Abraham Lincoln.

A third example is US Patent Application, US 2015/0058329 A1, “Clarification of Submitted Questions in a QA system,” filed on Feb. 26, 2015. It describes a mechanism that if it determines that clarification of an input question is required, a request is made for user input to clarify the question.

All three of these recent patent applications utilize additional information, in one way or another, to disambiguate natural language input to determine the intent behind the input. While not conceptualized and implemented in the same way, this invention also provides a means to gather feedback from users to apply more information to disambiguate verbal input and determine the intent behind the input. However, it gathers different information for this purpose than the information described in these three recent patent applications. It gathers information informed by instructional design, i.e., learning objectives, and learning sciences, i.e., different types of knowledge, and the needs of different types of learners to use for disambiguating natural language input and generating responses for learners.

This invention utilizes these different types of information to decrease the time and resources (i.e., costs) needed for SMEs to develop a QA system for their instructional materials. It utilizes the learning objectives of the instructional materials, the type of knowledge the learner is seeking, and the type of learner to recognize the intent behind learner questions. As a result, this invention provides a system and a method that guides SMEs in applying this information to easily and quickly develop an effective computer-based QA system for their own instructional materials.

### BACKGROUND—REFERENCES CITED

TABLE 1
U.S. Patent Documents

| Title | Publication Number | Filing Date | Assignee |
|---|---|---|---|
| Reading and | 5,920,838 | Jul. 6, 1999 | Carnegie Mellon |
| pronunciation tutor | | | University |
| Building and delivering | 8,750,782 | Jun. 10, 2014 | Scandura; Joseph |
| highly adaptive and | | | M |
| configurable tutoring | | | |
| systems | | | |
| Answering Questions | US 2016/0132590 | May 12, 2016 | IBM |
| Via a Persona-Based | A1 | | |
| Natural Language | | | |
| Processing (NLP) | | | |
| System | | | |
| Clarification of | US 2015/0058329 | Feb. 26, 2015 | IBM |
| Submitted Questions in | A1 | | |
| a QA system | | | |
| Providing Answers to | US 2013/0007055 | Jan. 3, 2013 | IBM |
| Questions Using | A1 | | |
| Multiple Models to | | | |
| Score Candidate | | | |
| Answers | | | |
| System and methods | Pat. No. 7,519,529 | Apr. 14, 2009 | Microsoft |
| for inferring | | | |
| informational goals and | | | |
| preferred level of detail | | | |
| of results in response to | | | |
| questions posed to an | | | |
| automated information- | | | |
| retrieval or question- | | | |
| answering service | | | |
| Navigating e-learning | 6,827,578 | Dec. 7, 2004 | SAP |
| course materials | | | Aktiengesellschaft |
| Natural language | US 2003/0144831 | Jul. 31, 2003 | Holy Grail |
| processor | | | Technologies, Inc. |

### OTHER PUBLICATIONS

Anderson, L. W., Krathwohl, D. R., Airasian, P. W., Cruikshank, K. A., Mayer, R. E., Pintrich, P. R., Raths, J. D., & Wittrock, M. C. (1998). Taxonomy for learning, teaching and assessing: A revision of Bloom's taxonomy of educational objectives. New York: Longman
Bloom, B. (1956). Taxonomy of behavioral objectives: handbook I: cognitive domain. New York: David McKay.
Burton, R. R. (1982). Diagnosing Bugs in a Simple Procedural Skill. In D. Sleeman & J. S. Brown (Eds.), Intelligent Tutoring Systems (pp. 157-184). New York: Academic Press.
Salisbury, M. (2014). “Embedding Learning within the Processes of Organizations,” International Journal of Knowledge—Based Organizations 4(1): 80-91.
Salisbury, M. (2009a). iLearning: How to Create an Innovative Learning Organization, San Francisco, Calif.: Pfeiffer (Imprint of Wiley).
Salisbury, M. (2009b). “A Framework for Managing the Life Cycle of Knowledge in Organizations,” International Journal of Knowledge Management 5(1): 61-77.
Salisbury, M. (2008a). “From Instructional Systems Design to Managing the Life Cycle of Knowledge in Organizations,” Performance Improvement Quarterly 13(3): 202-219.
Salisbury, M. (2008b). “A Framework for Collaborative Knowledge Creation,” Knowledge Management Research and Practice 6(3): 214-224.
Salisbury, M., Hendrickson, J., Lammers, T., Fu., C., and S. Moody (1990a). “Talk and Draw: Bundling Speech and Graphics,” IEEE Computer, Volume 23, Number 8, August.
Salisbury, M., Hendrickson, J., and T. Lammers, (1990b). “Combining Speech and Graphics,” Proceedings of Voice Systems Worldwide 1990, London, England.
Salisbury, M. (1988). “PARGEN: A Prototyping Tool for QA systems,” Proceedings of the Third Annual User-System Interface Conference, Austin, Tex.

### SUMMARY OF THE INVENTION

The present invention is a system and method for subject matter experts (SME) to easily, quickly, and effectively develop a computer-based Question and Answer (QA) system for their own instructional materials. The system is made up of third party components that have been augmented with templates filled with content, configured component connections, and computer logic needed to build a computer-based QA system for instructional materials. This system facilitates the method for SMEs to create instructional materials, configure the third-party components, create learning resources by modifying templates filled with content, configure component connections, and utilize templates of computer logic to develop a computer-based QA system for learners to ask questions and receive answers about instructional materials.

Third party-components of the system include a cloud-based data storage website, a cloud-based natural language processing (NLP) unit, a cloud-based interaction logic processor, and a cloud-based user interface generator. These components along with templates filled with content, component connections, and computer logic templates form a working example of a computer-based QA system for instructional materials. The method guides SMEs through the steps to turn the working example into a specific computer-based QA system for their own instructional materials.

The method, used by SMEs to develop a QA system for their instructional materials begins with SMEs determining the learning objectives for their materials. The method guides SMEs to identify the conditions, the change in behaviors attributed to the instruction, and a way to measure that change. For example, a learning objective in a course on emotional intelligence for identifying when another person is lying could be the following: “Detect that a person is lying in a face-to-face setting 80% or greater of the time.”

After the learning objectives are determined, SMEs identify the knowledge types that will be accessible to learners. As discussed in the Description of the Background section, learning scientists have extended the use of learning objectives to include addressing four different types of knowledge that learners may want to access given their level of expertise (Anderson, 1998). These different types of knowledge described are factual, conceptual, procedural, and metacognitive knowledge.

When the intent of learners is to access factual knowledge, i.e., the facts about what they need to do, their questions take the form of “WHAT do I do.” When the intent of learners is to access conceptual knowledge, i.e., the general principles and concepts behind what they need to do, their questions take the form of “WHY do I do it.” When the intent of learners is to access procedural knowledge, i.e., how they apply the general principles and concepts to do what they need to do, their questions take the form of “HOW do I do it.” And, when the intent of learners is to access metacognitive knowledge, i.e., the knowledge that experts have about when and where to do it, their questions take the form of “WHEN and WHERE do I do it.” The authoring system and the method provide SMEs with the capability to build a computer-based QA system that recognizes the intent of learners to access these four types of knowledge.

In addition, SMEs can create their own knowledge types. For example, a SME might add a knowledge type about company guidelines that learners can access to successfully achieve the learning objective, “Describe how to detect that a person is lying in a face-to-face setting.” This new knowledge type, “Company Guidelines,” provides access to knowledge about how company guidelines can be used to detect lying.

After the knowledge types that will be accessible to learners are determined, SMEs use the method to determine the types of learners that will use the system. SMEs start with a template filled with example learning resources for two types of learners—workers and stakeholders. SMEs edit the example learning resources to create the learning resources for their learners. SMEs can delete the learning resources for one or both of these learner types. SMEs can also create new learner types and tailor the learning resources for those types.

The method enables SMEs to develop a plurality of learning objectives that can be addressed by a plurality of knowledge types for a plurality of learners. This enables SMEs to build very broad QA systems for their instructional materials that respond to many questions relating to a wide variety of learning objectives, types of knowledge that learners are seeking, and many different types of learners. The method also enables SMES to build very narrow QA systems for their instructional materials that respond to few questions relating to a single learning objective, only one type of knowledge that learners are seeking, and only one type of learner.

One of the important advantages of the method is seen during the configuration of a NLP unit. Since the resulting QA system only focuses on the intent of learner questions related to the learning objectives, knowledge types, and types of learners, it's easier and quicker for SMEs to configure the NLP to develop an effective computer-based QA system.

After the NLP is configured, the SME configures a cloud-based data storage website, a cloud-based interaction logic processor, and the cloud-based user interface generator. The resulting system created by the SME is a cloud-based QA system for instructional materials that takes a learner question via text entry, processes the text to determine the intent of the learner's question, and displays a media rich (images, text, and links) response to the learner's question.

### BRIEF DESCRIPTION OF THE SEVERAL VIEWS OF THE DRAWINGS

FIG. 1 shows that third party-components of the system comprise a cloud-based data storage website, a cloud-based natural language processing (NLP) unit, a cloud-based interaction logic processor, and a cloud-based user interface generator.

FIG. 2 shows the cloud-based natural language processing (NLP) unit for this preferred embodiment of the invention. It's a screen capture of Microsoft's Language Understanding Intelligent Service (LUIS), a cloud-based NLP that is part of Microsoft's Cognitive Services.

FIG. 3 shows the template with prewritten potential questions from workers, i.e., primary learners, that SMEs edit within LUIS.

FIG. 4 shows the template with prewritten potential questions from stakeholders, i.e., secondary learners.

FIG. 5 shows the preferred embodiment for creating a cloud-based data storage website. It's a screen capture of a template used to create a Microsoft SharePoint site.

FIG. 6 shows the learning resources that the SMEs use to apply the method for developing a computer-based QA system for their own instructional materials.

FIG. 7 shows the template with learning resources that SMEs edit to create their own learning resources for the computer-based QA system for their instructional materials.

FIG. 8 shows the preferred embodiment, a Microsoft Flow implementation, of a cloud-based interaction logic processor.

FIG. 9 shows a connection has been made with a SharePoint site which will be linked to the cloud-based user interface.

FIG. 10 shows the preferred embodiment, a Microsoft's PowerApps implementation, of a cloud-based user interface generator.

FIG. 11 shows the overview of the method employed by the authoring system for Subject Matter Experts (SMEs) to easily, quickly, and effectively develop a computer-based Question and Answer (QA) system for their instructional materials.

FIG. 12 shows the two steps that comprise the method for creating a cloud-based data storage website.

FIG. 13 shows the three steps that comprise the method for SMEs to determine their learning objectives.

FIG. 14 shows that SMEs can use the method to create learning resources for a plurality of knowledge types.

FIG. 15, shows the SME has created learning resources to address the Company Guideline knowledge type for managers to achieve the “Describe how to detect that a person is lying in a face-to-face setting,” learning objective.

FIG. 16 shows that SMEs can use the method to create learning resources for a plurality of learner types.

FIG. 17 shows that the template that SMEs use to create their own learning resources has editable content for the learner type, stakeholders.

FIG. 18 shows the four steps that comprise the method for configuring a cloud-based natural language processing (NLP) unit.

FIG. 19 shows the three steps that comprise the method for configuring the logic for the cloud-based interaction logic processor.

FIG. 20 shows the three steps that comprise the method for configuring the cloud-based user interface generator.

FIG. 21 shows the resulting system created by the SME, a cloud-based QA system for instructional materials.

FIG. 22 shows the cloud-based QA system's logic to the display a learning resource to the learner.

FIG. 23 shows that the cloud-based QA system selects a learning objective from a plurality of learning objectives that were determined by the SME.

FIG. 24 shows that the cloud-based QA system selects the knowledge type from a plurality of knowledge types that were determined by the SME.

FIG. 25 shows that the cloud-based QA system selects the learner type from a plurality of learner types that were determined by the SME.

FIG. 26 shows that the cloud-based QA system uses the learning objective, knowledge type, and learner type to select and display the appropriate learning resource comprising text, media, links, and other media forms.

FIG. 27 shows the start-up of iTutor. It's cloud-based QA system and runs on most devices.

FIG. 28 shows a learner ask the question, “what do i do to tell if someone is lying.” iTutor identifies the learner's intent behind the question, and the system responds with a learning resource that describes what to do to tell if someone is lying.

FIG. 29 shows a different type of learner, a stakeholder, ask the question, “What content has been applied to projects?” This demonstrates that iTutor, a cloud-based QA system, can recognize and respond to a plurality of learner types.

FIG. 30 shows what happens when the learner's input indicates that the previous answer given by iTutor, the cloud-based QA system, did not identify the learner's intent behind the question. The iTutor responds by prompting the learner for additional input to identify the learner objective that represents the intent of the learner's question.

FIG. 31, shows iTutor, the cloud-based QA system, asking for additional input to identify the knowledge type that represents the intent of the learner's question.

FIG. 32, shows iTutor, the cloud-based QA system, asking for additional input to identify the learner type behind the learner's question.

FIG. 33 shows that iTutor, the cloud-based QA system, uses the learning objective, knowledge type, and learner type to display the learning resource that addresses the intent of the learner's question.

### DESCRIPTION OF THE PREFERRED EMBODIMENTS

The present invention is an authoring system and method for subject matter experts (SME) to easily, quickly, and effectively develop a computer-based Question and Answer (QA) system for their own instructional materials. The preferred embodiment of the authoring system is comprised of third party components that have been augmented with templates filled with content, configured component connections, and computer logic needed to build a computer-based QA system for instructional materials.

### The Authoring System

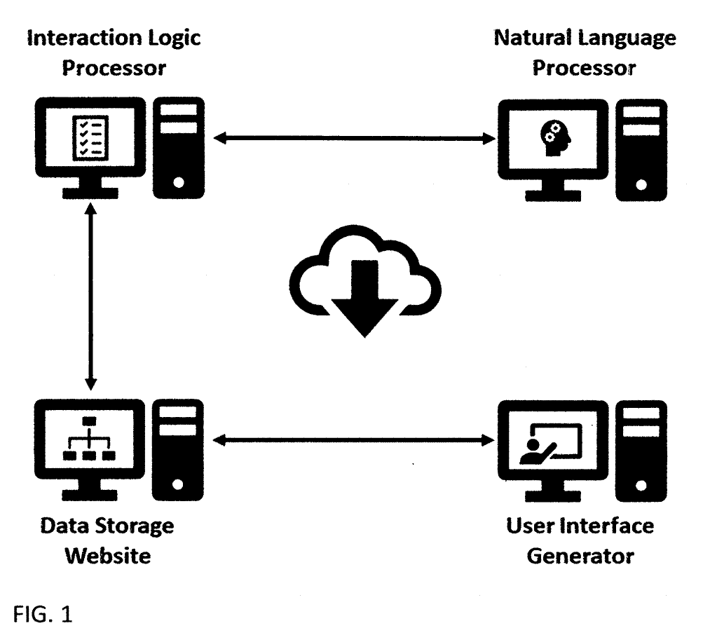

FIG. 1 shows that third party-components of the authoring system in the preferred embodiment for the invention comprise a cloud-based data storage website, a cloud-based natural language processing (NLP) unit, a cloud-based interaction logic processor, and a cloud-based user interface generator. FIG. 1 also shows that the configured component connections and computer logic provides two-way communication between a cloud-based interaction logic processor and a NLP unit, and two-way communication between a cloud-based interaction logic processor and a cloud-based data storage website. And, FIG. 1, shows that the configured component connections and computer logic provides two-way communication between a cloud-based data storage website and a cloud-based user interface generator. This communication mirrors the values in data fields for both; wherein updates to the cloud-based website are replicated in the cloud-based user interface generator and updates to the cloud-based user interface are replicated in the cloud-based website. When the completed QA system is fielded, updates to the cloud-based data storage website are seen in the cloud-based user interface that is created by configuring the cloud-based user interface generator.

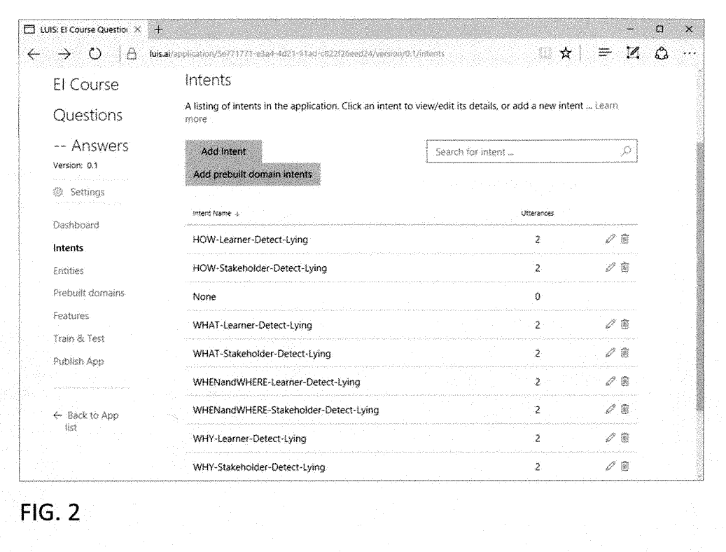

FIG. 2 shows the cloud-based natural language processing (NLP) unit for the preferred embodiment of the invention. It's a screen capture of Microsoft's Language Understanding Intelligent Service (LUIS), a cloud-based NLP that is part of Microsoft's Cognitive Services. Also shown in FIG. 2, is the template of prewritten Objective-Knowledge-Learner intents that SMEs load into LUIS. These intents are made by combining a learning objective, knowledge type, and learner type to recognize the learner's intent behind the learner's questions. SMEs use the method, described below, to modify the example Objective-Knowledge-Learner intents that come with the template, to configure LUIS to recognize learner questions about their instructional materials. Note that in FIG. 2, Objective-Knowledge-Learner intents are also present in the template where some learners are identified as stakeholders. SMEs can delete these intents, or add intents for other learner types. The system enables SMEs to configure LUIS to recognize questions from a plurality of learner types.

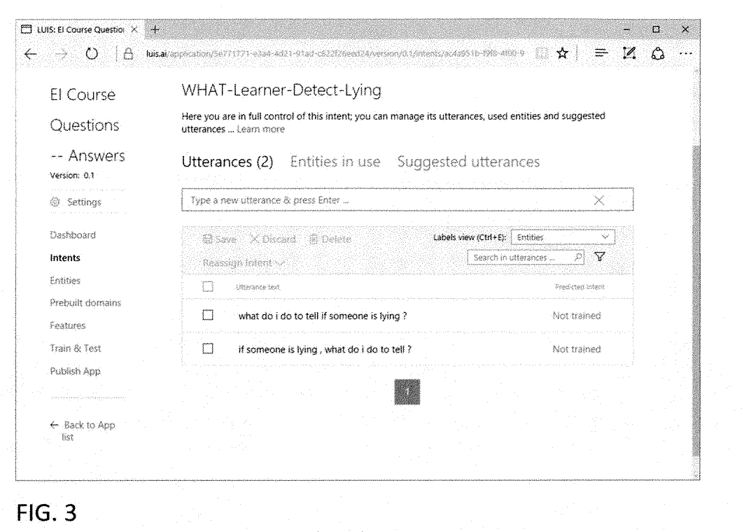

FIG. 3 shows the template with prewritten potential questions from primary learners that SMEs edit within LUIS. SMEs use the method, described below, to modify these questions and train LUIS on them.

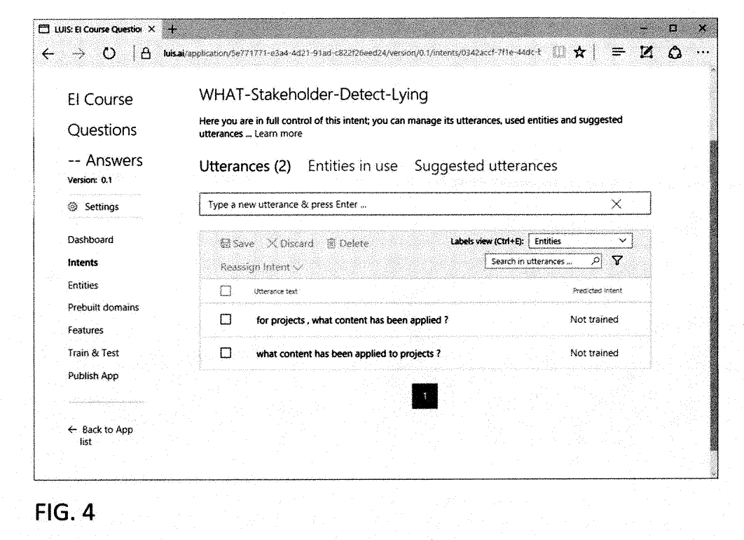

FIG. 4 shows the template that comes with prewritten potential questions from stakeholders, i.e., secondary learners. SMEs use the method, described below, to modify these questions and train LUIS on them. SMEs can use this template repeatedly to configure LUIS to recognize questions from a plurality of learner types.

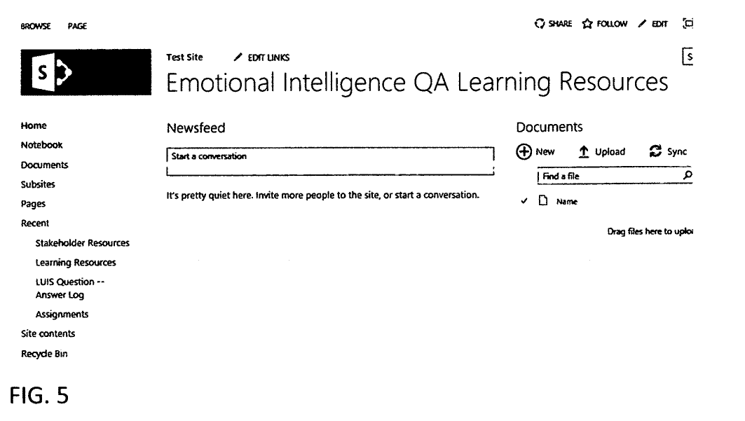

FIG. 5 shows the preferred embodiment for configuring a cloud-based data storage website. It's a screen capture of a template used to create and configure a Microsoft SharePoint site. SMEs use the method, described below, to modify the website name, field names, and data stored in the site to complement their instructional materials.

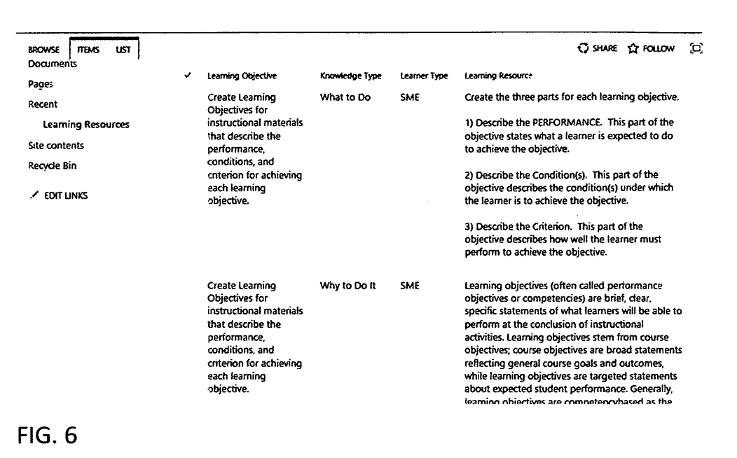

FIG. 6 shows the learning resources that SMEs use to apply the method, described below, to develop a computer-based QA system for their own instructional materials. In this preferred embodiment, they are also stored in a Microsoft SharePoint site. Shown in FIG. 6 are the learning resources that SMEs use to develop the learning objectives for their computer-based QA system.

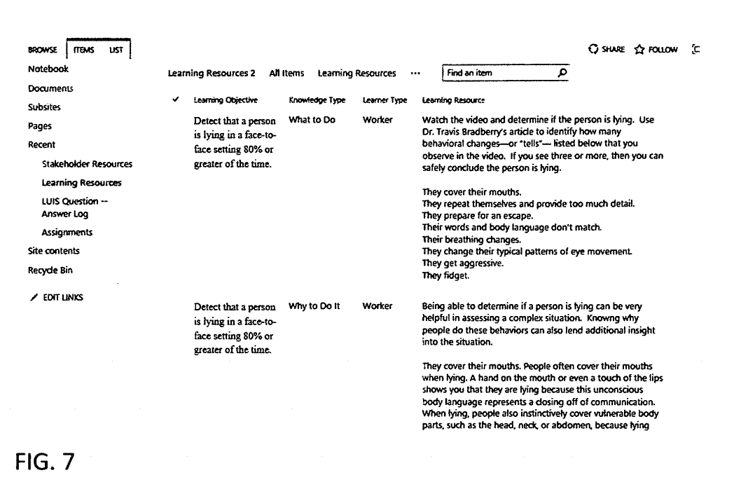

FIG. 7 shows the learning resources template that SMEs use to create their own learning resources for the computer-based QA system for their instructional materials. Described below, SMEs use the method to edit the fields to create learning resources used to generate responses for their computer-based QA system.

When FIG. 6 and FIG. 7 are compared, it shows that SMEs experience the same format for learning resources that their learners will experience when their learners use the SMEs completed QA system.

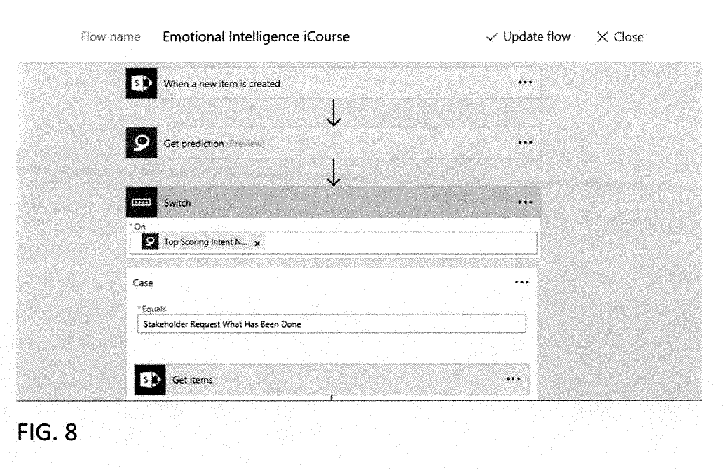

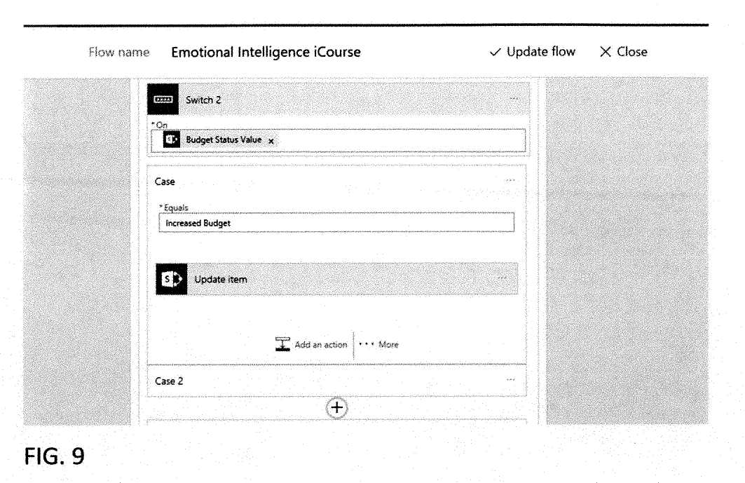

FIG. 8 shows the preferred embodiment, a Microsoft Flow implementation, of a cloud-based interaction logic processor. FIG. 8 also shows the template with prewritten logic that the SMEs use to configure Flow for their computer-based QA system. The SharePoint icon shows a connection has been established with a SharePoint website. The Microsoft Cognitive Services icon in FIG. 8 shows a connection has been established with Microsoft's NLP, LUIS. The Update SharePoint icon in FIG. 9 shows a connection has been made with the SharePoint site which will be linked to the end user interface when the cloud-based user interface generator is configured.

At the time of this writing, SMEs follow the method and use the learning resources provided with the authoring system to create the template with prewritten logic for Microsoft Flow. Microsoft has plans to add a feature in Flow where users can export and import templates with prewritten logic. When this feature is available, the system and method described here will be changed so that SMEs will be able to configure Flow by simply importing a template that comes with the system like they do with LUIS and PowerApps.

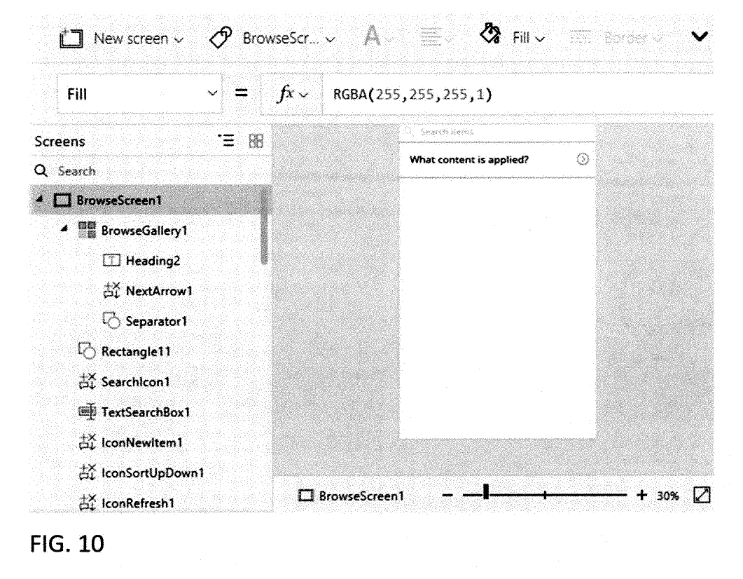

FIG. 10 shows the preferred embodiment, a Microsoft's PowerApps implementation, of a cloud-based user interface generator. FIG. 10 also shows the template, supplied by PowerApps, that SMEs use to configure the user interface of their completed computer-based QA system.

### The Method

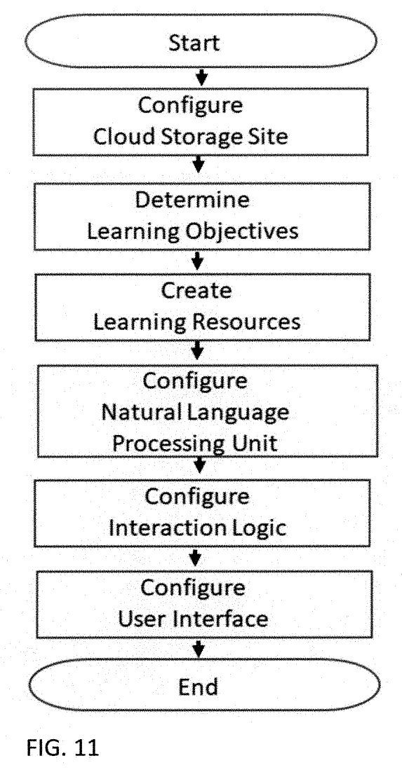

FIG. 11 shows the overview of the method employed by the authoring system for Subject Matter Experts (SMEs) to easily, quickly, and effectively develop a computer-based Question and Answer (QA) system for their instructional materials. SMEs begin by configuring a cloud-based storage website. Next, they determine the learning objectives for their instructional materials. Then, they create the learning resources for the cloud-based storage website. Afterwards, SMEs configure a cloud-based natural processing unit, interaction logic processor, and a user interface generator.

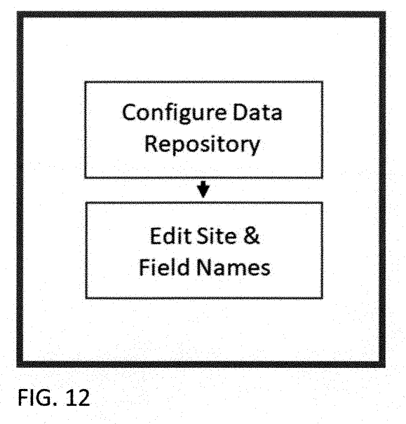

FIG. 12 shows the two steps of the method for configuring a cloud-based data storage website. The first step is to use the website template to create a data repository. This repository needs to be accessible via the Internet and be secure, i.e., have a login with a security level. The second step is to edit the site and the data field names in the repository. FIG. 7 shows what it looks like when its created on a cloud-based Microsoft SharePoint site. Note that the learning resources are stored in the repository. Also, the learner's questions and the generated answers are also stored in data fields in the repository.

FIG. 6 shows the learning resources that are available to the SMEs that will guide them to determine their learning objectives for their instructional materials. Note that these learning resources will be similar in format to the learning resources that SMEs will create and make available for their learners through the computer-based QA system they will develop. Also, note that in this preferred embodiment, these learning resources were created, organized, and reside on a cloud-based Microsoft SharePoint site. Other embodiments of this invention could use different cloud-based data storage websites to create and store these learning resources.

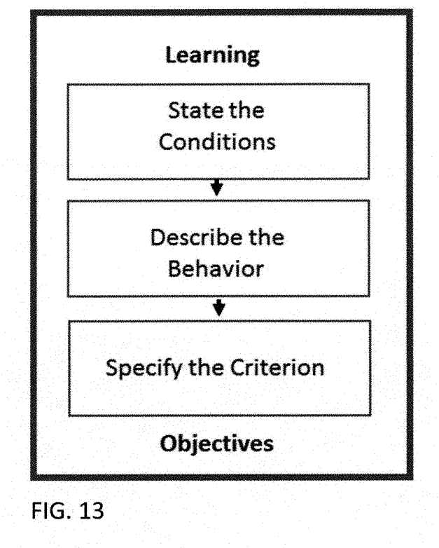

FIG. 13 shows the three steps in the method for SMEs to determine their learning objectives. The first step is for SMEs is to state the conditions under which each learning objective is to be achieved. The second step is for them to describe the behavior that is to be observed in the learner after achieving the learning objective. The third step for SMEs is to specify the criterion to judge whether the learning objective has been achieved. For example, a learning objective in a course on emotional intelligence for identifying when another person is lying could be the following: “Detect that a person is lying in a face-to-face setting 80% or greater of the time.” Here the condition is “face-to-face setting,” the behavior is “Detect that a person is lying,” and “80% or greater of the time,” is the criterion.

After the learning objectives are determined, SMEs identify the knowledge types that will be accessible to learners. As discussed in the DESCRIPTION OF THE BACKGROUND section, learning scientists have extended the use of learning objectives to include addressing four different types of knowledge that learners may want to access given their level of expertise (Anderson, 1998). These different types of knowledge described are factual, conceptual, procedural, and metacognitive knowledge. FIG. 7 shows the editable template that SMEs use to create their own learning resources for their computer-based QA system. The template is filled with example learning resources that provide access to the four types of knowledge identified by learning scientists. When the intent of learners is to access factual knowledge, i.e., the facts about what they need to do, their questions take the form of “WHAT do I do.” When the intent of learners is to access conceptual knowledge, i.e., the general principles and concepts behind what they need to do, their questions take the form of “WHY do I do it.” When the intent of learners is to access procedural knowledge, i.e., how they apply the general principles and concepts to do what they need to do, their questions take the form of “HOW do I do it.” And, when the intent of learners is to access metacognitive knowledge, i.e., the knowledge that experts have about when and where to do it, their questions take the form of “WHEN and WHERE do I do it.”

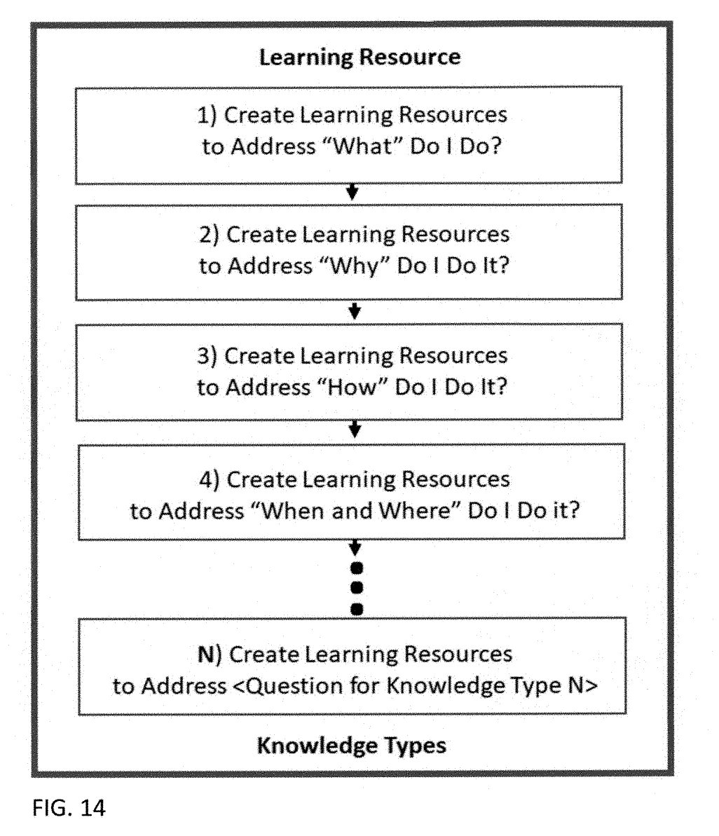

FIG. 14 shows that SMEs can use the method to create learning resources for a plurality of knowledge types. SMEs use the template to determine what knowledge types that learners will be able to access. SMEs edit the fields that relate to the knowledge type of each learning resource. As shown in FIG. 7, for example, a SME may determine that the learners of his or her computer-based QA system will only have access to factual and conceptual knowledge. So, the SME deleted the learning resources with the values “HOW” (procedural knowledge) and “WHEN and WHERE” (metacognitive knowledge) in the knowledge type field. Then, the SME edited the learning resources with the “WHAT” (factual knowledge) and “WHY” (conceptual knowledge) knowledge type fields to create the learning resources that the SME's learners will use to achieve the learning objective, “Detect that a person is lying in a face-to-face setting 80% or greater of the time”.

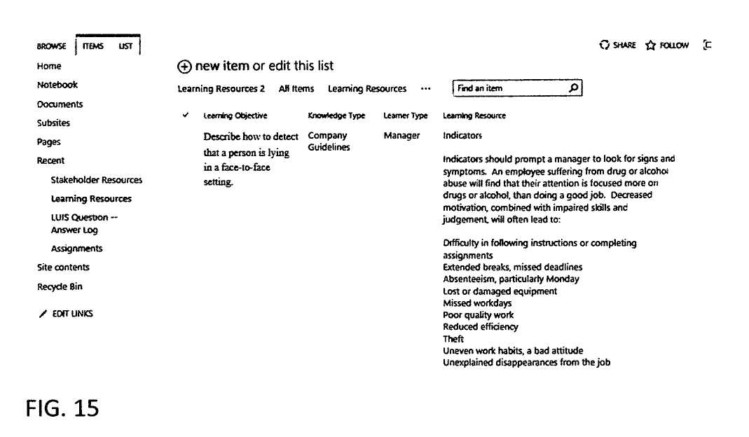

As shown in FIG. 15, SMEs can create their own knowledge types. For example, a SME might add a knowledge type about company guidelines that the learners will have to address to successfully achieve a new learning objective. FIG. 15 shows the results of the SME adding a new learning resource and entering “Company Guidelines” in the knowledge type field along with the new learning objective. The SME populated the learning resource with the company guidelines that pertain to achieving the new learning objective “Describe how to detect that a person is lying in a face-to-face setting.” As described later, the knowledge types determined by the SMEs in this step will become the knowledge types that the NLP can recognize in the questions entered by learners when they use computer-based QA system.

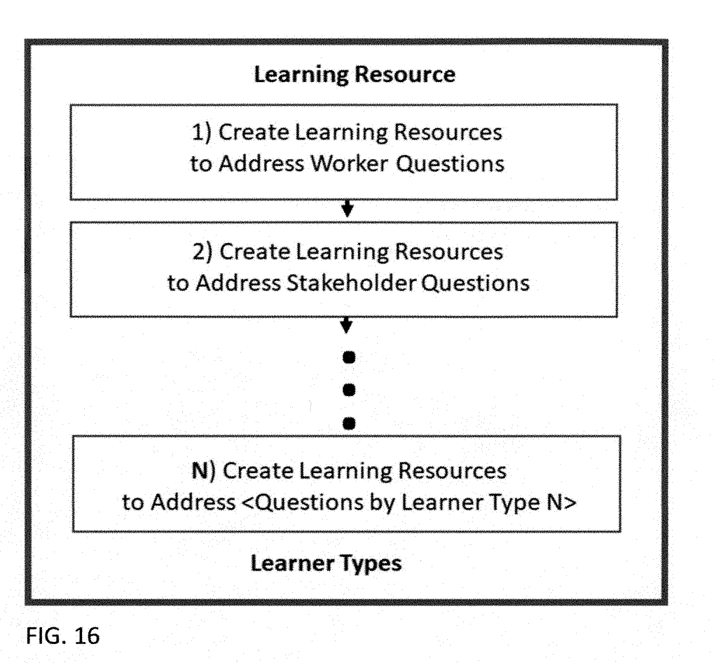

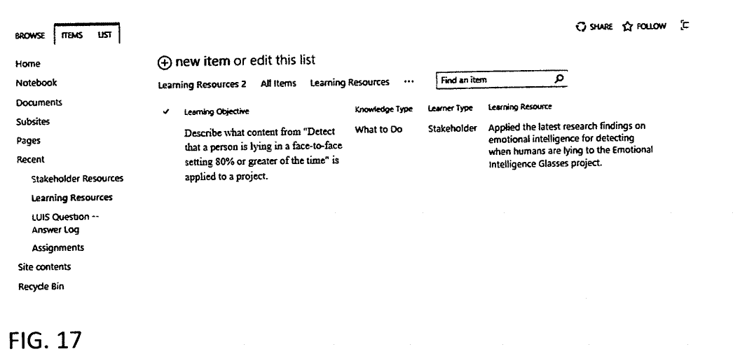

After the knowledge types that will be accessible to learners are determined, SMEs use the method to determine the types of learners that will use the system. FIG. 16 shows that SMEs can use the method to create learning resources for a plurality of learner types. As FIG. 7 and FIG. 17 show, the template that SMEs use to create their own learning resources comes with editable content for two types of learners. SMEs can edit the template to create learning resources for workers and stakeholders. SMEs can also delete the learning resources for one or both of these learner types. As shown in FIG. 15, the method also enables SMEs to create new learner types and tailor the learning resources to those types. The learning resource created for the Company Guidelines” knowledge type also created a new type of learner—a manager. As described later, the learner types determined by the SMEs in this step will become the learner types that the NLP can recognize in the questions entered by learners when they use computer-based QA system.

As these examples show, the method enables SMEs to develop a plurality of learning objectives that can be addressed by a plurality of knowledge types for a plurality of learners. This enables SMEs to build very broad QA systems for their instructional materials that respond to many questions relating to a wide variety of learning objectives, type of knowledge that the learner is seeking, and many different types of learners. The method also enables SMES to build very narrow QA systems for their instructional materials that respond to only a few questions relating to a few learning objectives, with limited types of knowledge that learners are seeking, and only one type of learner.

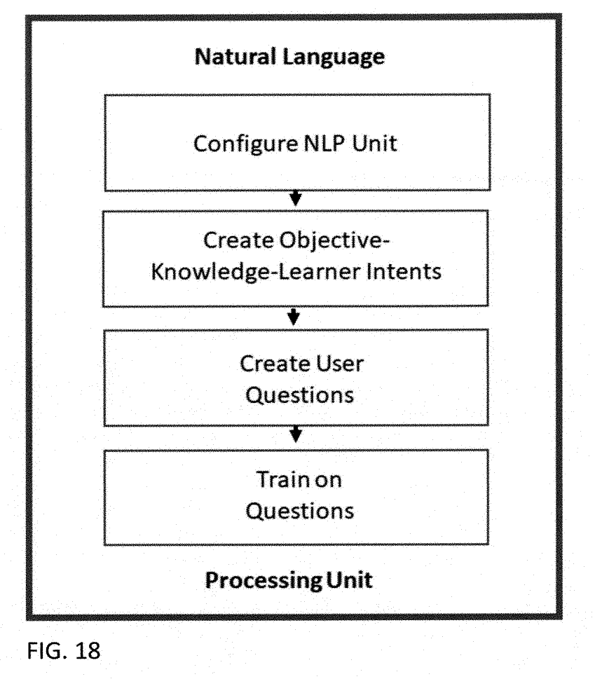

FIG. 18 shows the four steps that comprise the method for configuring a natural language processing (NLP) unit. The first step is to configure the NLP unit with a template filled with content. In this preferred embodiment shown in FIG. 2, the NLP unit that is configured is Microsoft's Language Understanding Intelligent Service (LUIS), a cloud-based NLP that is part of Microsoft's Cognitive Services.

The second step is to create the learner intents, i.e., the intent of learners behind questions, for each learning objective, knowledge type, and learner type combination. Also shown in FIG. 2, the method guides SMEs to modify a LUIS template populated with example Objective-Knowledge-Learner intents. FIG. 4 shows how this preferred embodiment for an NLP unit, can support a plurality of learner types. In this example, a SME has modified the template to create the following intents for stakeholders: “WHAT-Stakeholder-Detect-Lying,” “WHY-Stakeholder-Detect-Lying,” “HOW-Stakeholder-Detect-Lying,” and “WHENandWHERE-Stakeholder-Detect-Lying.”

FIG. 18 shows that the third step in the method is to create potential questions that learners may ask when trying to achieve a learning objective. In the preferred embodiment, shown in FIG. 3, SMEs use a template with example potential questions from primary learners that they edit within LUIS. For example, a learner may want to know what the steps are to achieve a learning objective and ask, “What do I do to detect that a person is lying?” Note that when the NLP processes this question it will return the learner intent WHAT-Learner-Detect-Lying. Another question that represents this intent is “If someone is lying, what do I do to tell?” With this input given to the NLP, it would also return the learner intent WHAT-Learner-Detect-Lying. Potential learner questions are also created for the remaining learner intents. For this example, the SME also created potential learner questions for the WHY-Learner-Detect-Lying, HOW-Learner-Detect-Lying, and WHENandWHERE-Leamer-Detect-Lying learner intents.

FIG. 4, also implemented with LUIS, shows that stakeholder questions are different than learner questions indicating that stakeholders require a different response to address the intent of their questions. The way the method addresses this requirement is by guiding SMEs to create unique learning objectives for each learner type. This means that the learner who does the work has to learn to apply what is presented in the instructional materials while the learner who is just interested in the status of the work may only have to describe what has been done. With this method, SMEs can create the ability for an NLP to recognize input from a large number of learner types by creating the learner intents for each learner type. Again, FIG. 3 and FIG. 4 show an implementation in Microsoft's LUIS. However, other NLPs, such as IBM's Watson, have the capability to support the method as described.

The fourth step, shown in FIG. 18, is to train the NLP on the potential questions against their learner intents which are comprised of a learning objective knowledge type, and learner type combination. In training, the NLP associates a set of example questions with one of the learner intents. After training, when one of the sentences that the NLP has been trained on is entered by a learner, the appropriate learner intent is returned—meaning that the intent of the learner is “understood.” Note that most NLP units will recognize similar questions to the ones they have been trained on and will return the correct learner intent. This flexibility is actually the reason to use a NLP for this purpose.

The method described here greatly reduces the work of configuring a NLP unit. Instead of trying to anticipate all possible questions that a user might enter, this system has SMEs focus on creating responses for each learning intent which are comprised of a learning objective, knowledge type, and learner type combination. By restricting the NLP processing to only questions about the learning intents, fewer categories, i.e., learner intents, of questions need training by the NLP—and fewer possible questions are needed for each category. And, since fewer questions need to be differentiated from one another, the NLP's accuracy is also improved with this method.

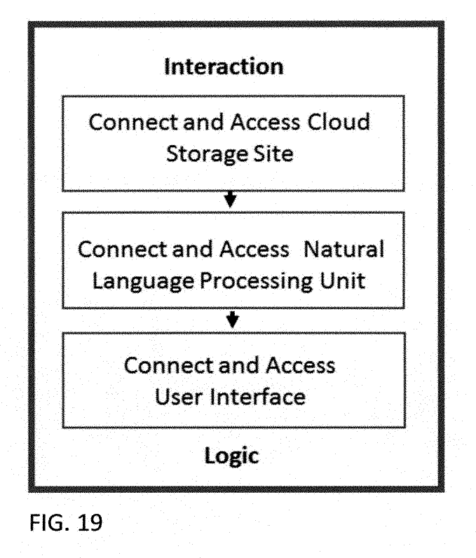

After the NLP is configured, the SME configures the cloud-based interaction logic processor that manages the human/computer interaction. FIG. 19 shows that three steps comprise the method for configuring the interaction logic of the computer-based QA system. The first step is to use the template with prewritten logic in the cloud-based interaction logic processor to connect to the cloud-based data storage website. As shown in FIG. 8, a Microsoft Flow implementation, this is done by clicking on an icon, e.g., the SharePoint icon, to navigate to the location of the cloud-based data storage website and selecting it. As mentioned above in the authoring system section, at the time of this writing, SMEs follow the method and use the learning resources provided with the authoring system to create the template with prewritten logic for Microsoft Flow.

The second step is to connect the interaction logic manager to the cloud-based NLP. In FIG. 8, the Microsoft Cognitive Services icon shows a connection has been established with Microsoft's NLP, LUIS. This requires SMEs to enter sign in credentials for LUIS into the logic template of Flow.

The third step is to connect the interaction logic manager to the end user interface. The Update SharePoint icon in FIG. 9 shows a connection has been made with the SharePoint site which will be linked to the end user interface when the cloud-based user interface generator is configured. Again, this is done by clicking on an icon, e.g., the SharePoint icon, to navigate to the location of the cloud-based data storage website.

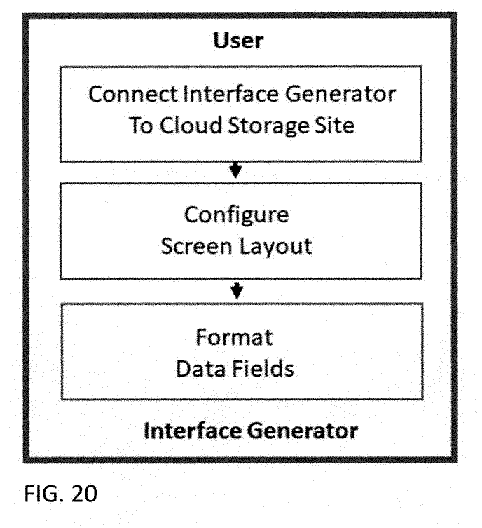

FIG. 20 shows that three steps comprise the method for configuring the cloud-based user interface generator. FIG. 10 shows an embodiment using Microsoft's PowerApps for the cloud-based user interface generator. In FIG. 20, the first step is to connect the cloud-based user interface generator to the cloud-based data storage website. The second step is to configure the screen layout. The third step is to format the data fields for the end user interface.

After the cloud-based user interface generator is configured, the resulting system created by the SME is a cloud-based QA system for instructional materials that takes learner input via text entry, processes the text to determine the intent of the learner's question, and displays a media rich (images, text, and links) response to the question. The next section shows how this QA system for instructional materials would work for learners in an actual setting.

### Cloud-Based QA System for Instructional Materials

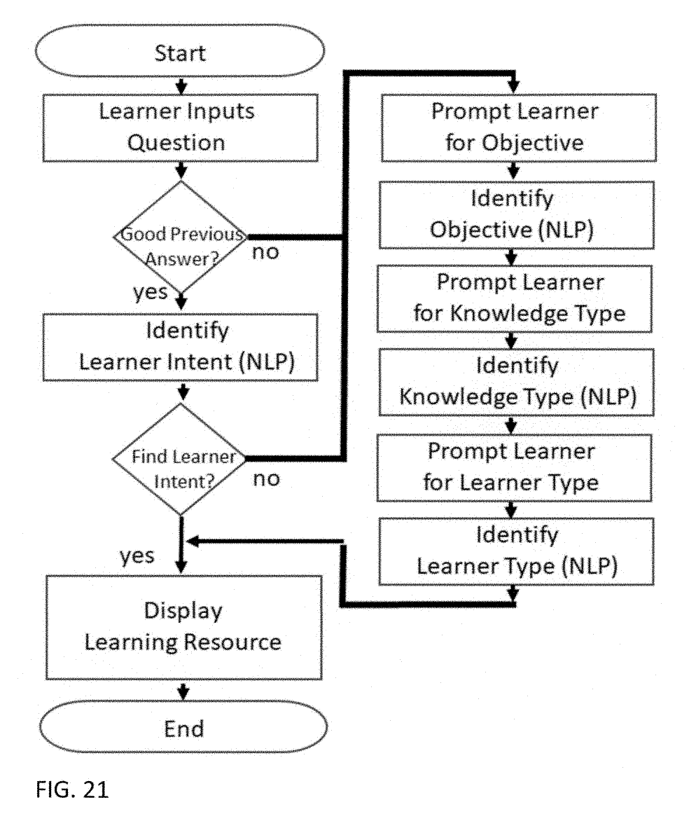

FIG. 21 shows the logic flow of the resulting system created by the SME, a cloud-based QA system for instructional materials. It's made up of third party-components that includes a cloud-based data storage website, a cloud-based natural language processing (NLP) unit, a cloud-based interaction logic processor, and a cloud-based user interface. These components along with templates filled with content, component connections, and computer logic templates form a computer-based QA system for instructional materials.

FIG. 21 shows how the computer-based QA system for instructional materials works for learners. The process begins when a learner enters a question. The learner's question is evaluated to see if the previous answer given by the computer-based QA system was satisfactory to the learner. If the previous answer was not a good one, then, the cloud-based interaction logic processor prompts the learner for additional input. If it was a good previous answer, then the new question is passed on to the NLP, by the cloud-based interaction logic processor, to identify the learner intent behind the learner's question. The NLP returns it's results to the cloud-based interaction logic processor. If the learner intent is identified, then the cloud-based interaction logic processor displays the appropriate learning resource; else, the cloud-based interaction logic processor, prompts the learner for additional input. When the cloud-based interaction logic processor prompts for additional input, it passes the input to the NLP and receives the results back from the NLP. The cloud-based interaction logic processor first asks the learner to identify the learning objective that represents the intent of the learner's question, then it asks for the type of knowledge that represents the learner intent of the learner's question, and, then it asks for the type of learner that represents the intent of the learner's question. With all three of these requests for input satisfied, the cloud-based interaction logic processor displays the appropriate learning resource to the learner.

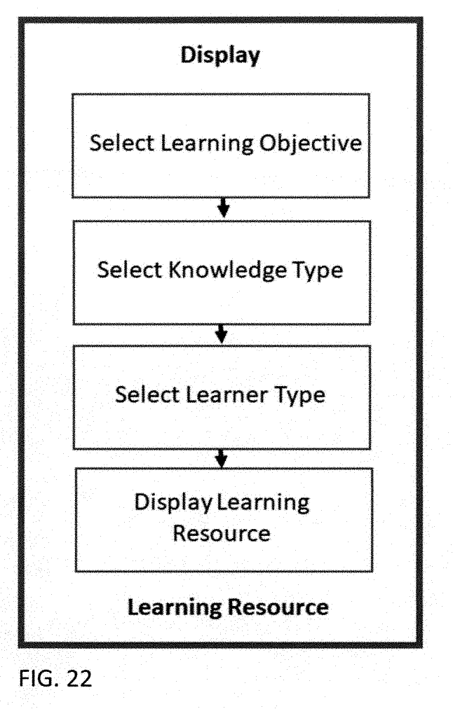

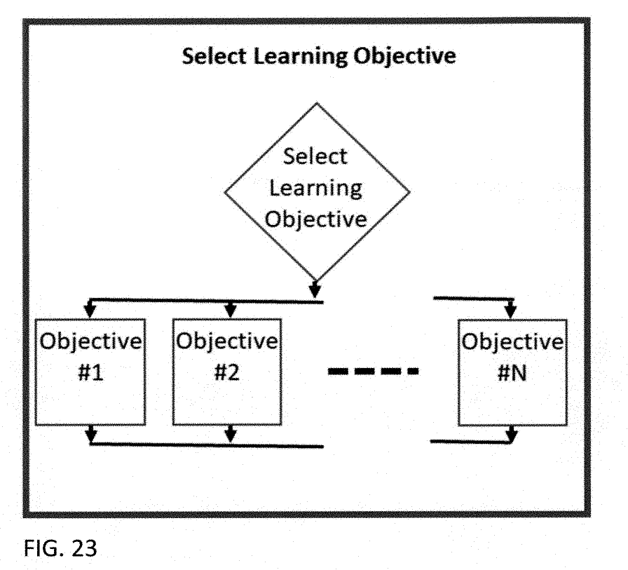

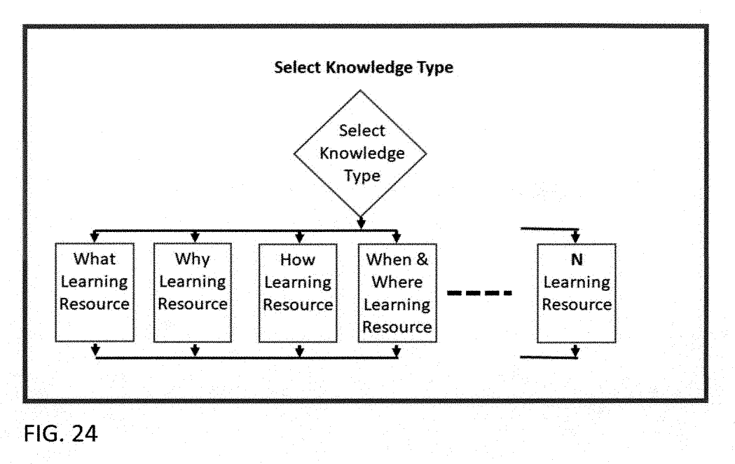

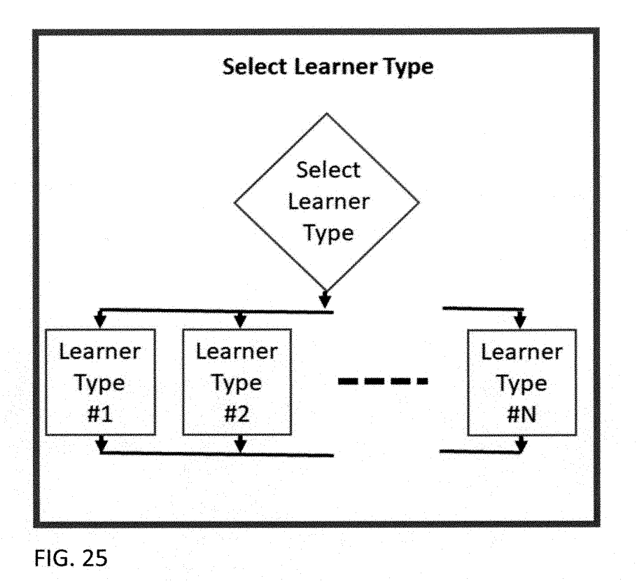

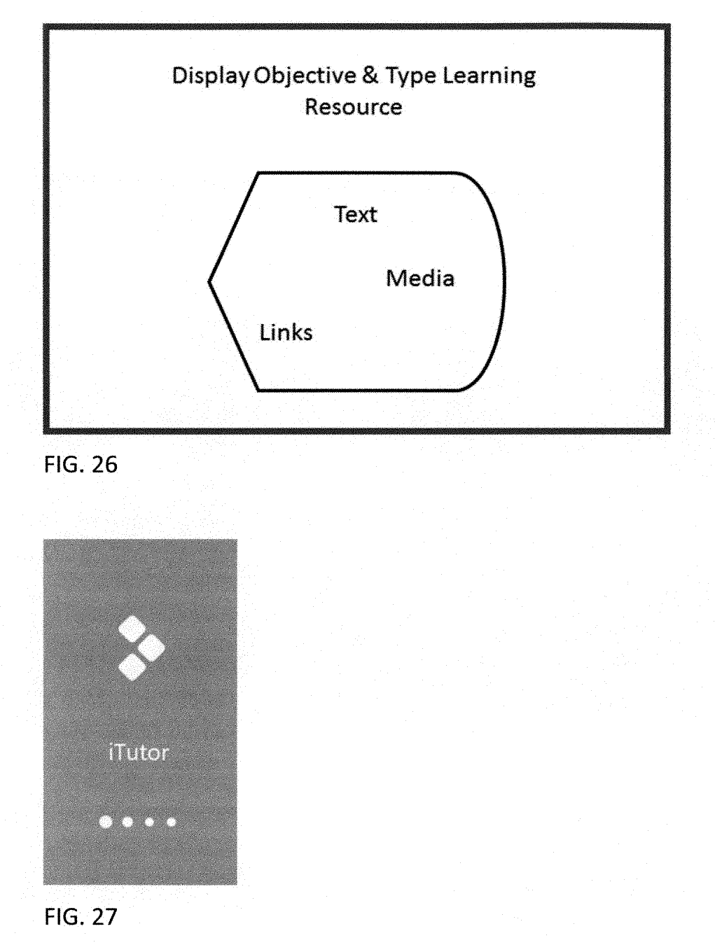

FIG. 22 shows the computer-based QA system's logic to display the appropriate learning resource to the learner. FIG. 23 shows that the cloud-based interaction logic processor first selects a learning objective from a plurality of learning objectives determined by the SME. Next, FIG. 24 shows that the cloud-based interaction logic processor selects the knowledge type from a plurality of knowledge types determined by the SME. Next, FIG. 25 shows that the cloud-based interaction logic processor selects the learner type from a plurality of learner types determined by the SME. And, FIG. 26 shows that the cloud-based interaction logic processor uses the learning objective, knowledge type, and learner type combination to select and display the appropriate learning resource made up of text, media, links, and possibly other media forms.

### Implementation of the Invention

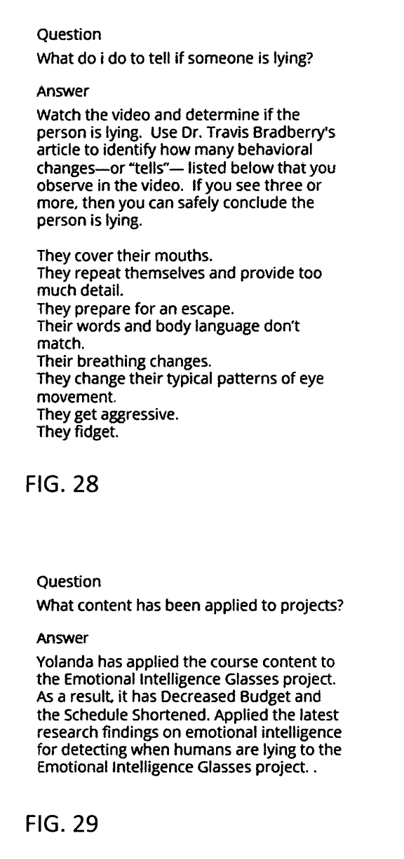

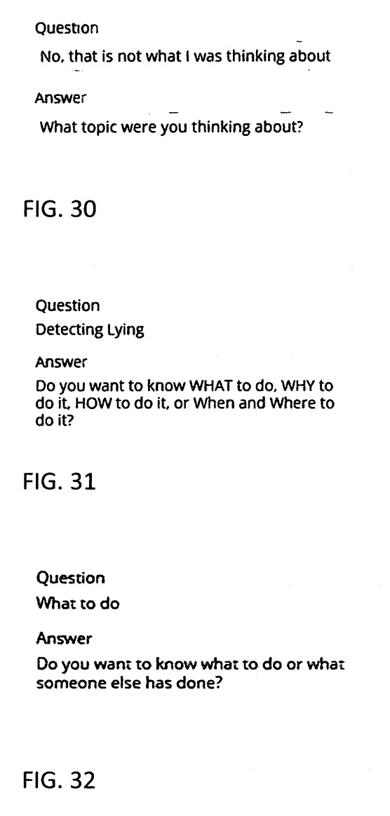

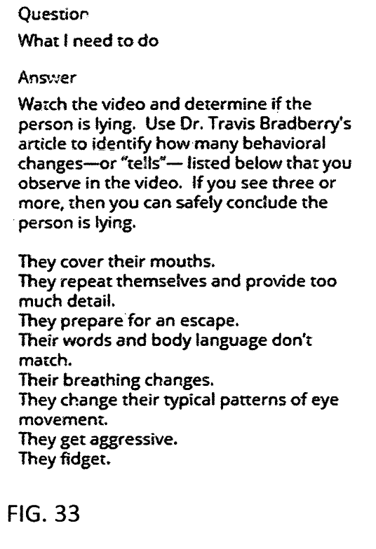

FIG. 27, FIG. 28, FIG. 29, FIG. 30, FIG. 31, FIG. 32, and FIG. 33 show an interaction with an actual implementation of the invention, called iTutor, that employs Microsoft technology for the third-party components. Microsoft's SharePoint was used as the cloud-based data storage website. Microsoft's Language Understanding Intelligent Service (LUIS), a part of Microsoft's Cognitive Services, was used as the cloud-based natural language processing (NLP) unit. Microsoft's Flow was used for the cloud-based interaction logic processor; and Microsoft's PowerApps was used for the cloud-based user interface generator.

These Microsoft third-party components were assembled into a system augmented with templates filled with content, configured component connections, and computer logic needed to build a computer-based QA system for instructional materials. The resulting implementation of the system and the method described here was used to create instructional materials, configure the third-party components, create learning resources by modifying templates filled with content, configure component connections, and utilize templates of computer logic to develop a computer-based QA system for learners to access instructional materials.

FIG. 27 shows the start-up of iTutor. It's cloud-based and runs on most devices.

FIG. 28 shows a learner ask the question, “what do i do to tell if someone is lying.” The computer-based QA system follows the logic of FIG. 21, with the NLP identifying the learner's intent behind the question, and the system responds with a learning resource that describes what to do to tell if someone is lying.

FIG. 29 shows a different type of learner, a stakeholder, ask the question, “What content has been applied to projects?” Again, the computer-based QA system follows the logic of FIG. 21, with the NLP identifying the learner's intent behind the stakeholder's question, and the system responds with a learning resource that describes what content has been applied to projects. This demonstrates that a computer-based QA system developed by a SME can support a plurality of learner types.

FIG. 30 shows what happens when the learner's input indicates that the previous answer by the NLP did not identify the learner's intent behind the question. The computer-based QA system responds by prompting the learner for additional input to first identify the learner objective that represents the intent of the learner's question. Next, in FIG. 31, the system asks for additional input to identify the knowledge type that represents the intent of the learner's question. Then, in FIG. 32, the system asks for additional input to identify the learner type behind the learner's question. FIG. 33 shows that the computer-based QA system uses the learning objective, knowledge type, and learner type to display the learning resource that correctly represents the intent of the learner's question.

### Alternate Ways of Implementing the Invention

iTutor, is an implementation of the invention described here, “An Authoring System for Subject Matter Experts (SMEs) to develop a Computer-Based Question and Answer (QA) system for their Instructional Materials.” It is implemented with third-party components developed by Microsoft. The templates filled with content, configured component connections, and computer logic needed to build a computer-based QA system for instructional materials have been created for these Microsoft components.

However, this invention can also be implemented with other third-party component developers. Most notably, it could be implemented with IBM third-party components. IBM's Watson can serve as the cloud-based NLP, while IBM's Bluemix, a cloud-based app development environment, can be used to create the cloud-based interaction logic processor and the cloud-based user interface generator. Also, there are other cloud-based technologies that can be used to create these third-party components such as NLP units from university research programs and alternate cloud-based development environments. And, since these components live in the cloud, an embodiment of this invention could be a mix of many different suppliers for these components needed to implement the authoring system and method described here.

### Extensions of the Invention

There are a number of logical extensions to the invention described here. One of the obvious extensions is to attach a speech recognition unit to the user interface. SMEs could then develop a QA system that can process spoken input. A speech synthesizer could also be added to the user interface. The resulting system could respond to learner questions in spoken language. For example, SMEs could develop a system where learners talk to phones and receive spoken responses similar to talking with a person with deep expertise about a subject.

### Potential Commercial Uses of the Invention

The invention described here, “An Authoring System for Subject Matter Experts (SMEs) to develop a Computer-Based Question and Answer (QA) system for their Instructional Materials,” has many potential commercial uses that include—but are not limited to—the following:
Licensed product or service for individuals or organizations to manage their own proprietary knowledge around their own organization's processes. SMEs use the system and method to create QA systems that step other workers, i.e., learners, through organizational processes.
Licensed product or service for to individuals or organizations to create QA systems to deliver their educational and training content.
Licensed product or service for organizations to create QA systems to provide helpdesk or call center services to their customers.
Licensed product or service for organizations to create QA systems and embed them in their products or services as a help function. Potential customers include providers of “Internet of Things” products and services.

What is claimed is:

1. A computer-based authoring system for Subject Matter Experts (SMEs) to develop a computer-based Question and Answer (QA) system for their computer-based instructional materials, comprising:
(a) editable templates for configuring a cloud-based data storage website;
(b) editable templates for configuring a cloud-based natural language processing unit (NLP);
(c) editable logic templates for configuring a cloud-based interaction logic processor; and
(d) editable templates for configuring a cloud-based interface generator.

2. A template for a cloud-based data storage website, as claimed in claim 1, further comprising data fields for input and output; and editable learning resources.

3. A template for a cloud-based NLP, as claimed in claim 1, further comprising editable information representing the intended content that learners seek with their questions, categorized by learning objectives, knowledge types, and types of learners.

4. A template for a cloud-based NLP, as claimed in claim 1, further comprising editable potential learner questions.

5. A logic template for a cloud-based interaction logic processor, as claimed in claim 1, further comprising modifiable logic that manages input and displays responses for a cloud-based storage website and a cloud-based user interface.

6. A logic template for a cloud-based interaction logic processor, as claimed in claim 1, further comprising modifiable logic that sends input to a NLP unit and receives output from the NLP unit.

7. A logic template for a cloud-based interaction logic processor, as claimed in claim 1, further comprising modifiable logic prompting learners for the intended learning objective, knowledge type, and type of learner behind their questions.

8. A logic template for a cloud-based interaction logic processor, as claimed in claim 1, further comprising modifiable logic that selects and displays learning resources based upon the intended learning objective, knowledge type, and type of learner.

9. A method for SMEs to develop a computer-based Question and Answer (QA) system for their computer-based instructional materials, comprising the steps of:
(a) configuring a cloud data storage website;
(b) determining learning objectives;
(c) creating learning resources;
(d) configuring a cloud-based NLP;
(e) configuring a cloud-based interaction logic processor; and
(f) configuring a cloud-based computer interface generator.

10. A method as claimed in claim 9, wherein said step of configuring a cloud-based data storage website comprises the steps of:
(a) creating a data repository with a template filled with content; and
(b) editing the website and the data field names in the repository.

11. A method as claimed in claim 9, wherein said step of configuring a cloud-based computer interface generator comprises the steps of:
(a) applying template filled with content;
(b) connecting to cloud data storage website;
(c) identifying fields in cloud-based data storage website and connecting them to the generated cloud-based computer interface; and
(d) formatting data fields in the cloud-based computer interface.

12. A method as claimed in claim 9, wherein said step of determining learning objectives comprises the steps of:
(a) stating the conditions of the learning objectives;
(b) describing the behavior for a learner to achieve with the learning objectives; and
(c) describing the criterion for a learner to successfully achieve the learning objectives.

13. A method as claimed in claim 9, wherein said step of creating learning resources comprises the steps of:
(a) determining the knowledge types that will be accessible to learners;
(b) determining the types of learners who will use the system;
(c) creating learner intents, representing the intended content that learners seek with their questions, categorized by learning objectives, knowledge types, and types of learners; and
(d) creating learning resources to address each learner intent comprising a learning objective, knowledge type, and learner type.

14. A method as claimed in claim 9, wherein said step of configuring a cloud-based NLP comprises the steps of:
(a) applying template filled with content;
(a) entering learner intents, representing the intended content that learners seek with their questions, categorized by learning objectives, knowledge types, and types of learners;
(b) creating potential learner questions; and
(c) training the NLP unit with potential learner questions.

15. A method as claimed in claim 9, wherein said step of configuring a cloud-based interaction logic processor comprises the steps of:
(a) applying template filled with logic;
(b) configuring logic for connecting and accessing a cloud-based data storage website;
(c) configuring logic for connecting and accessing a cloud-based NLP unit; and
(d) configuring logic for connecting and accessing a cloud-based user interface.

16. The use of the authoring system, as claimed in claim 1, and application of the method, as claimed in claim 9, results in the creation of a computer-based Question and Answer (QA) system, comprising:
(a) a configuration for a cloud-based data storage website;
(b) a configuration for a cloud-based NLP;
(c) a configuration for a cloud-based interaction logic processor; and
(d) a configuration for a cloud-based user interface.

17. The use of the authoring system, as claimed in claim 1, and application of the method, as claimed in claim 9, results in the creation of a computer-based Question and Answer (QA) system, comprising executable logic for performing the following:
(a) capturing learner input;
(b) ensuring that learning objective, question type, and type of learner are identified; and
(c) displaying the appropriate learning resource.

18. A system as claimed in claim 17, further comprising capturing learner input when logic is executed, performs the step of:
(a) entering learner question in data field on cloud-based user interface.

19. A system as claimed in claim 17, further comprising ensuring that learning objective, question type, and type of learner are identified when logic is executed, performs the steps of:
(a) passing input to NLP unit by the cloud-based interaction logic processor;
(b) retrieving output from NLP unit by the cloud-based interaction logic processor;
(c) finding the learning objective, question type, and type of learner combination with the cloud-based interaction logic processor; and
(d) prompting the learner for the intended learning objective, knowledge type, and type of learner with the cloud-based interaction logic processor if not found.

20. A system as claimed in claim 17, further comprising display appropriate learning resource when logic is executed, performs the steps of:
(a) finding the associated learning resource for the learning objective, question type, and type of learner combination with the cloud-based interaction logic processor; and
(b) writing the learning resource in the data field of the cloud-based data storage website and connected cloud-based user interface by the cloud-based interaction logic processor.
